(19) United States
(12) Patent Application Publication
(10) Pub. No.: US 2002/0158922 A1
(43) Pub. Date: Oct. 31, 2002

(54) Portable real-time traffic information device and method

(76) Inventors: Richard L. Clark, Westlake Village, CA (US); Ike J. Song, Montebello, CA (US)

Correspondence Address: FLESHNER & KIM, LLP, P.O. Box 221200, Chantilly, VA, 20153-1200, US

(21) Appl. No.: 10/116,755

(22) Filed: Apr. 5, 2002

Related U.S. Application Data
(60) Provisional application No. 60/281,299, filed on Apr. 5, 2001.

(51) Int. Cl. G09G 5/00

(52) U.S. Cl. 345/864

(57) ABSTRACT

A real-time and portable graphical traffic information display device and method is provided. The real-time traffic information can be gathered for various agencies using multiple technologies. Real-time traffic information can be provided to a subscriber 24 hours a day, 7 days a week. In a preferred embodiment, the portable display device includes a full color fixed map of a region's roadway system with LEDs (light emitting diodes) illuminating with various colors and/or blinking at different intervals to indicate traffic conditions at the locations represented by the LED.

This application claims priority to U.S. Provisional Application No. 60/281,299, filed Apr. 5, 2001, which is hereby incorporated by reference in its entirety.

### BACKGROUND OF THE INVENTION

1. Field of the Invention

The present invention relates generally to a graphical information display system and more specifically, it relates to a graphical information display system configured to receive data over a paging transmitting system.

2. Background of the Related Art

Although graphical information display systems can display different types of information, such as weather conditions, roadway surface conditions, etc., they will be discussed herein in the context of displaying information relating to motor vehicle traffic.

One type of related art traffic information display system is a static, non-portable traffic information system such as an internet download, or a cable TV transmission of a traffic map. With these types of systems, the user receives the traffic information at a single location, usually the user's home, before traveling or commuting. The main problem with such information systems is that the information is in static or un-undatable form because it is obtained via an internet download or a cable TV transmission and is thus not portable. Furthermore, because the information is static, this method can not provide real-time information as the user travels. These static, non-portable traffic information systems are not well-suited for travelers and commuters because such users cannot update the traffic information once they start traveling.

Another type of related art traffic information system is a verbal description of traffic conditions via a commercial radio broadcast. With this system, a user receives verbal traffic reports over the vehicle's radio while traveling or commuting. The problem with such broadcasts is that the provided traffic information is unreliable, because it is limited in scope and not timely. Often, the roads addressed in the traffic report are not of interest to the traveler or commuter, or the information provided is no longer accurate. Thus, because of its unreliability, such radio broadcasts rarely compels the user to change his/her driving route, and are of limited use.

Another related art method of obtaining traffic information is having the traveler place a telephone call to a live traffic information operator by using, for example, a mobile telephone. The problem with this method is that, although it does provide traffic information and optimal route suggestions, it is only a snap shot of traffic conditions at the time the call was placed. A traveler or commuter must call repeatedly, using a mobile telephone with its associated costs, to obtain up-to-date traffic information during travel. Additionally, some drivers may not feel safe using a mobile telephone while operating a motor vehicle. In fact, the use of mobile telephones in moving vehicles is being substantially limited in many jurisdictions.

Another type of related art traffic information display system is a wireless “push-type” data transmission or transfer to a personal digital assistant (PDA) device for a fee. In this type of system, traffic information is transmitted to a user's PDA while traveling or commuting. A push-type data transmission or transfer is one in which the flow of data is controlled by the sending device. The problem with these types of systems is that the PDA screen is small and PDAs have awkward human machine interfaces (HMIs), making it difficult to receive and view the traffic information while operating a motor vehicle. Another complication associated with the use of a PDA to display traffic information is that one often has to navigate multiple menu screens on the PDA to receive the traffic information. If the information sent to the PDA is graphical in nature, e.g., a map display, than the PDA method is also slow, because a large amount of data must be transmitted and received to display the graphical information. This is because the entire screen or display must be “repainted” or re-created pixel-by-pixel for each traffic update. Another disadvantage of the PDA approach is the relatively high cost of the monthly subscription typically charged by the wireless service provider.

Another type of related art traffic information display system uses a paging-type signal transmission to mobile telephones or conventional pagers. The paging transmissions include alpha-numeric traffic information that is tailored to an individual user's needs. For purposes herein, “page transmission,” “paging transmission, and “pager broadcast” are all used synonymously to refer to the transfer of data using electromagnetic signals broadcast over messaging systems. The problem with these systems is that the alpha-numeric traffic information received via paging transmissions is very limited in scope due to the limited alphanumeric display capability (typically less than 60 characters) of current pager displays. Thus little traffic information can be displayed by the paging device.

The above references are incorporated by reference herein where appropriate for appropriate teachings of additional or alternative details, features and/or technical background.

### SUMMARY OF THE INVENTION

An object of the present invention is to solve at least the above problems and/or disadvantages and to provide at least the advantages described hereinafter.

Another object of the present invention is to provide a real-time and portable traffic information device using pager, FM sub-carrier transmission, AM radio, shortwave radio, microwave communication, satellite radio, Digital Audio Broadcasting, cell phone, Global Systems for Mobile Communications, Wireless Application Protocol, etc. technologies, including any range of transmission and reception frequencies of such technologies, that will overcome the shortcomings of the related art devices.

Another object of the present invention is to provide a real-time and portable traffic information device to provide real-time traffic information to consumers using pager, FM sub-carrier transmission, AM radio, shortwave radio, microwave communication, satellite radio, Digital Audio Broadcasting, cell phone, Global Systems for Mobile Communications, Wireless Application Protocol, etc. technologies, including any range of transmission and reception frequencies of such technologies.

Another object of the present invention is to provide inexpensive and portable access to real-time traffic information.

Another object of the present invention is to provide portable access to real-time traffic information using one-way or two-way paging technology.

Another object of the present invention is to provide an information system that uses a single pager number to communicate traffic information to multiple portable units within a predetermined geographic area.

Another object of the present invention is to provide a real-time and portable device that contains a fixed map and light emitting diodes (LEDs) that indicate traffic flow.

Another object of the present invention is to provide a plurality of information devices, wherein each device has a unique identifier so that each device can be switched off or on using remote triggering paging commands.

Another object of the present invention is to provide a plurality of information devices, wherein each device has a unique identifier circuit and/or a unique identifier number that can be replaced by other identification technologies, including a smart chip set that can be installed by users.

Another object of the present invention is to provide a real-time and portable traffic information device that functions only when the user's subscription is current.

Another object of the present invention is to provide a real-time and portable traffic information device with optional text, radio, and voice messaging features.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram of a traffic information collector and display system;

FIG. 2 is a block diagram showing additional details of the sensor of FIG. 1, in accordance with one embodiment of the present invention;

FIG. 3 is a block diagram of one preferred embodiment of the raw data collector of FIG. 1;

FIG. 4 is a block diagram of one preferred embodiment of the data display of FIG. 1;

FIG. 5 is a block diagram of one pager chip set that can be used in the data display of FIG. 1;

FIG. 6 is a block diagram of a unique identification decoder that can be used on the data display of FIG. 1;

FIG. 7 is a block diagram of a removable smart chip set that can be used on the data display of FIG. 1;

FIG. 8 is a block diagram of a power supply that can be used on the data display of FIG. 1;

FIG. 9 illustrates a LED control data set that can be used in the data display of FIG. 1;

FIG. 10 is a schematic view of a graphical platform that can be used as a data display in accordance with the present invention;

FIG. 11 illustrates an embodiment of the traffic information display system in use on a roadway in accordance with the present invention; and

FIG. 12 illustrates an embodiment of the traffic information display system.

### DETAILED DESCRIPTION OF PREFERRED EMBODIMENTS

In view of the foregoing problems and disadvantages in the prior art, an embodiment of the present invention provides a new real-time and portable traffic information device using pager, FM sub-cartier transmission, AM radio, short wave radio, microwave communication, satellite radio, Digital Audio Broadcasting, cell phone, Global Systems for Mobile Communications, Wireless Application Protocol, etc. technologies, including any range of transmission and reception frequencies of such technologies, to transmit and/or receive information over an information transmission system.

In most metropolitan areas, traffic information is gathered from the region's roadways and provided to various government agencies using multiple technologies such as remote cameras and magnetic sensors. However, due to difficulties in accessing this information, such traffic data is not readily available to the consuming public for personal use. To provide simple and efficient access to traffic information, an embodiment of the present invention is provided to allow portable real-time access to traffic information to a subscriber on a 24 hours a day, 7 days a week basis. For purposes herein, the terms “user” and “subscriber” are used synonymously to denote a person who use a traffic information system to receive traffic information.

A preferred embodiment of the invention is a portable traffic information system which displays traffic conditions in real time. Due to the device's portability, traffic information can be accessed whether the user is at home or work, in a car or restaurant, etc. Access to the traffic information is provided to subscribers for a fee. By knowing where traffic congestion is at all times, a subscriber may avoid travel delays by taking an alternate driving route to a particular destination, or by postponing travel until the traffic congestion has subsided. Thus, timely access to traffic information can reduce a user's travel or commute time, as well as reducing wear and tear on the road infrastructure which minimizes road repairs and the need for new roads.

The real-time and portable traffic information device using pager, FM sub-carrier transmission according to an embodiment of the present invention substantially departs from the conventional concepts and designs of the related art. This new portable apparatus is well-suited to provide real-time traffic information to consumers using paging or FM sub-carrier transmission and/or reception technology. The real-time and portable traffic information device can also be adapted to, use AM radio, short wave radio, microwave communication, satellite radio, Digital Audio Broadcasting, cell phone, Global Systems for Mobile Communications, Wireless Application Protocol, etc. technologies, including any range of transmission and reception frequencies of such technologies.

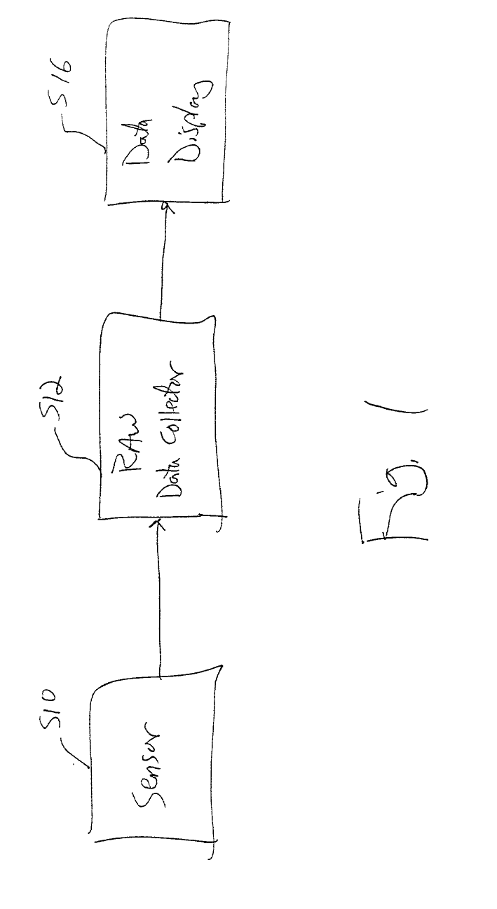

Referring to FIG. 1, a block diagram of a traffic information collection and display system, in accordance with the present invention, is shown. As indicated in FIG. 1, the data flow starts when a sensor S10 collects raw traffic data.

Once the sensor S10 has collected raw traffic data, the data is transmitted to a raw data collector S12. Transmission of data between the sensor S10 and the collector S12 can be done by any of various means of data transmission known in the art such as a RF transmission, or transmission over a metallic cable such as a coaxial cable or a telephone line, as well as transmission through a fiberoptic.

The raw data collector S12 is typically located in a facility or unit operated by the same entity responsible for maintenance or construction of the roadways. Such entities typically include federal and state governments, but can also include county and municipal governments, as well as a private business.

Once the data has been collected at the raw data collector S12, the data is transmitted to the data display S16. The data can be formatted by the raw data collector S12 prior to transmission to the data display S16 in any of a variety of formats known in the data transmission arts, such as an analog signal or a digital signal, and may include encryption methods to protect against data tampering and data theft. The data can be transmitted to the data display S16 through a variety of data transmission technologies known in the art. Such data transmission techniques include transmission over, to and from a pager system as, for example, as used for a telephone pager. Information transmission may also include transmission over, to and from a satellite, as well transmission over, to and from a cell phone network. The phrase “cell phone network” includes any of the channels used by the cell phone network including, but not limited to, paging and traffic channels. The phrase also includes the use of short messaging service (SMS) protocols. Additional information transmission systems may incorporate, AM radio, short wave radio, microwave communication, Digital Audio Broadcasting, Global Systems for Mobile Communications, Wireless Application Protocol, etc. technologies, including any range of transmission and reception frequencies of such technologies. Any of these transmission technologies can be further extended by the use of transmission repeaters.

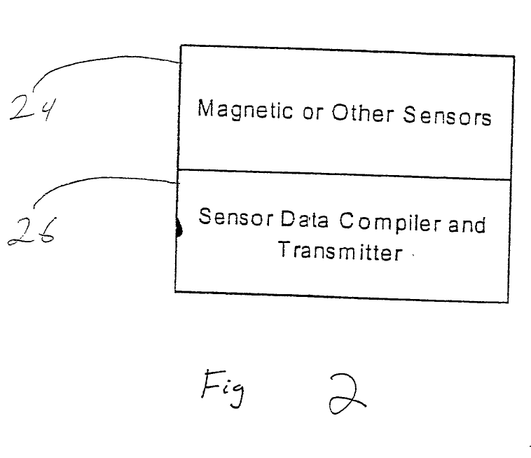

Referring to FIG. 2, a block diagram of additional details of the sensor S10 of FIG. 1, in accordance with one embodiment of the present invention. The sensor S10 may include magnetic and/or other sensors 24 and a sensor data compiler and transmitter 26. The other types of sensors that may be used include pressure switches, vibration detectors, interruptible light beams, video cameras, radar detectors, etc. Additionally, weather sensors, airline flight monitors, inventory monitors, etc. may also be used. There are various sensors known in the art that can be used to collect traffic data, including cameras and surface embedded sensors. A surface embedded sensor is a sensor embedded in the surface of the roadway and designed to detect the presence of a vehicle. Such sensors can include magnetic sensors and vibration sensors, as well as vehicle weight sensors. Other types of traffic sensors include beam interrupt sensors where the presence of a vehicle interrupts a beam projected across the roadway, and radar detectors where a radar system detects the presence of a vehicle. A radar detector also has the advantage of detecting a vehicle's speed. Another type of sensor can include a system where traffic information is manually entered by a human observer.

Other types of sensors can include sensors oriented towards collecting local weather and road surface conditions. For example such sensors can include sensors to detect the presence of ice or standing water on a road's surface. Such sensors can also detect the condition of wind, fog, blowing sand or dust, as well as the presence of smog and/or smoke. It should be noted that some embodiments of the invention include multiple sensors, and such multiple sensors can include any combination of sensors.

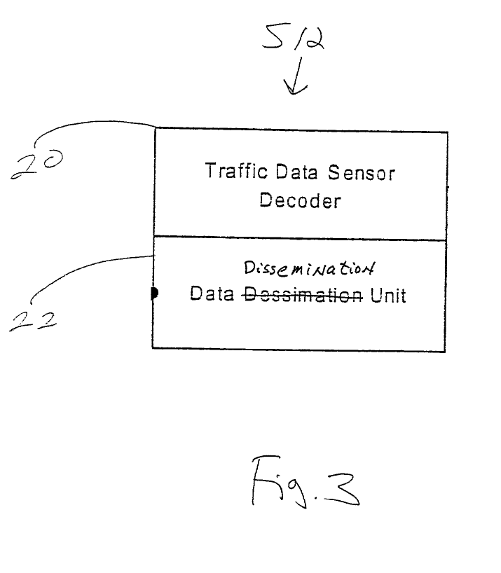

Referring to FIG. 3 a block diagram of one preferred embodiment of the raw data collector S12 is shown. The raw data collector S12 may include a traffic data sensor decoder 20 and a data dissemination unit 22. The traffic data sensor decoder 20 functions to decode data received from the sensor S10 depending, for example, on the transmission format or data type, and the data dissemination unit 22 functions to transmit the data to the data display S16. Although the example shown includes a traffic data sensor decoder 20, other types of information can be decoded, such as weather information, warehouse information, airline flight information, etc.

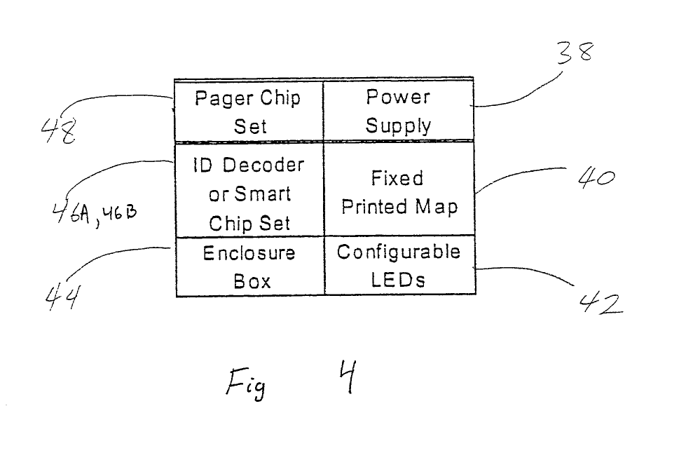

Referring to FIG. 4 a block diagram of one preferred embodiment of the data display S16 of FIG. 1 is shown. The data display S16 may include a power supply 38, a fixed printed map 40, configurable LEDs 42, an enclosure box 44, and ID decoder 46A or smart chip set 46B, and a pager chip set 48.

In operation, the power supply 38 provides power to the data display. The ID decoder 46A or smart chip set 46B may control the functioning of the data display depending on whether the user has a current subscription to the information service. The ID decoder 46A or smart chip set 46B can also control functioning based on other parameters as chosen by the system operator. The pager chip set 48 receives information through a pager type transmission or, alternatively, another type of electromagnetic transmission. The pager chip set 48 decodes the received transmission and provides a decoded signal to the electrical circuitry configured to operate the configurable LEDs 42. The configurable LEDs 42 may be housed in an enclosure box 44, which also may include a fixed printed map 40. The configurable LEDs 42 are preferably disposed on the fixed printed map 40 in a prescribed manner relative to the fixed printed map 40.

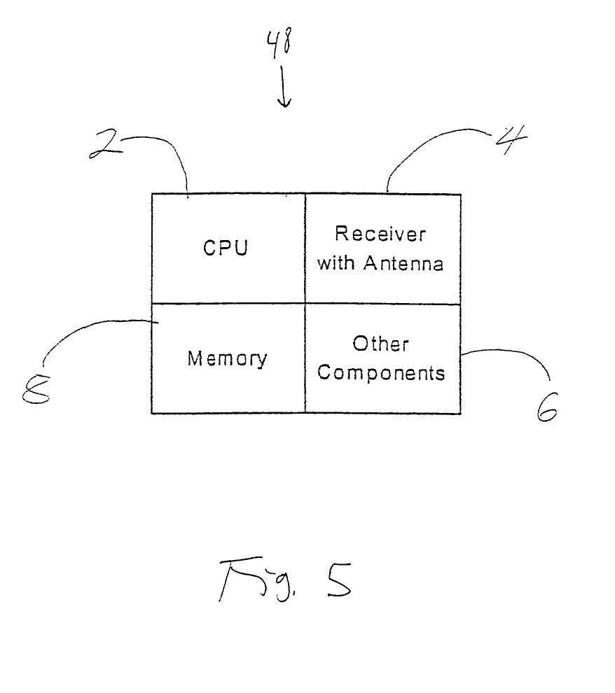

Referring to FIG. 5, a block diagram of a pager chip set 48 that can be used in the data display S16 is shown. The pager chip set 48 shown includes a CPU 2, a receiver with an antenna 4, a memory 8, as well as other components 6. In a preferred embodiment, the CPU 2, the receiver with an antenna 4, the memory 8, and other components 6 cooperatively interact to receive information in the form of pager signals. Such information can then be displayed in a variety of formats, but preferably a graphical format.

The pager chip set 48 traffic is preferably a uni-directional or bi-directional chip set. Uni-directional paging chip sets utilize wireless information push technology. Bi-directional paging chip sets can be configured to provide additional features including but not limited to customized wireless information push transfers for individual unique ID chip sets.

An alternate method to using a paging transmission and/or reception technology is FM sub-carrier technology. Most all communication protocol of paging technology is similar to FM sub-carrier technology, and preferred embodiments of the present invention can be used with either paging or FM sub-carrier technology. Other embodiments of the invention can also be adapted to AM radio, short wave radio, microwave communication, satellite radio, Digital Audio Broadcasting, cell phone network, Global Systems for Mobile Communications, Wireless Application Protocol, etc. technologies, including any range of transmission and reception frequencies of such technologies. As discussed above, the phrase “cell phone network” includes any of the channels used by the cell phone network, including, but not limited to, paging and traffic channels. The phrase also includes the use of short messaging service (SMS) protocols.

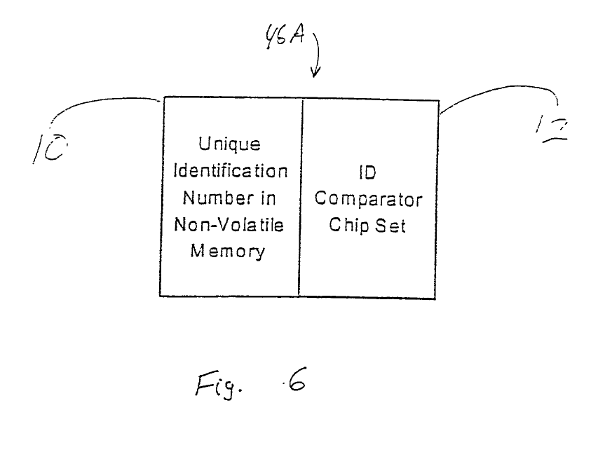

FIG. 6 is a block diagram of a unique identifier (ID) decoder 46A that can be used in the data display S16. The unique ID decoder 46A is an example of a device which may be used to control access to information received via the information transmission system. The unique ID decoder 46A includes an identification number in a non-volatile memory 10 that is unique to an individual data display S16, and an ID comparator chip set 12. The unique ID decoder 46A uses the unique identification number 10 to determine whether the data display S16, into which the unique ID decoder 46 is incorporated, should be allowed to function (e.g., whether a user should be allowed to access information transmitted to the data display S16).

If a subscription service is used for providing traffic information to the data display S16, the unique ID decoder 46A is preferably used to differentiate a subscriber from a non-subscriber. For this type of application, the unique identification number in non-volatile memory 10 will be compared with incoming messages. If the incoming message has the same unique identification number, the data display S16 will be turned on by any one of various means known in the art.

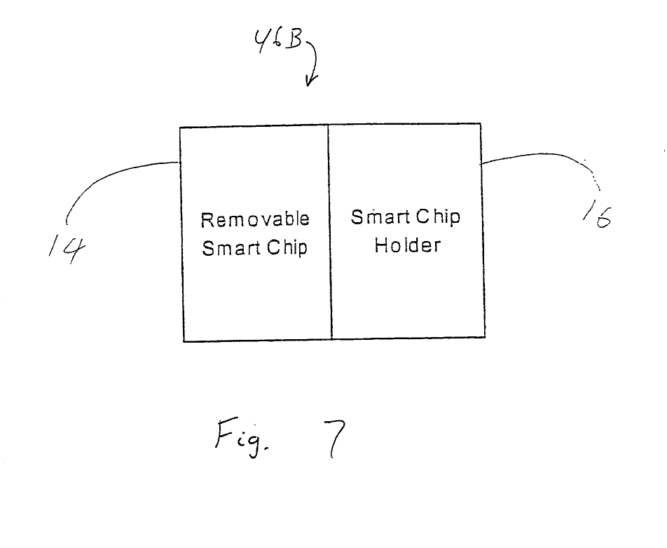

Alternatively, a removable smart chip set 46B, such as the one shown in FIG. 7, may be used to control access to information received through an information transmission system. The removable smart chip set 46B includes a removable smart chip 14, and a smart chip holder 16. A device which incorporates the removable smart chip 14 can be configured to operate only when a current smart chip 14 is installed. The smart chip 14 can be configured to “expire” after a prescribed time period has elapsed, thus disabling the data display S16. The data display S16 can be re-activated by installing a current removable smart chip 14, such as one received after a service agreement has been renewed.

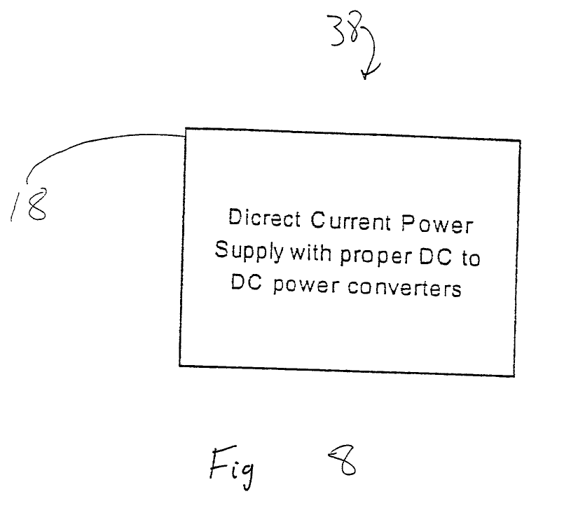

Referring to FIG. 8 a block diagram of a power supply 18 which may be used to provide to power the data display S16 is shown. The power supply 18 may used to supply power to the circuitry of a graphical image display in the data display S16, as well as associated components. Although a direct current power supply is shown, other types of power supplies, such as batteries, may used. Additionally, the system may be configured to be powered by an alternating current source.

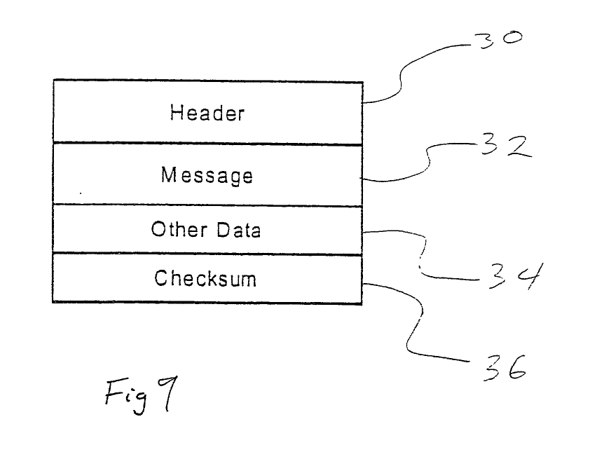

Referring to FIG. 9, a block diagram of an LED control data set that can be used in the data display S16 of FIG. 1 is shown. The LED control data set includes a header 30, a message 32, other data 34, and checksum 36. The control data set is one example of the structure of messages sent over the information transmission system. In the example shown, the LED control data set includes the header 30 as the first part of the data set, followed by the message 32. The message 32 may contain most of the data being transmitted in the LED control data set. The LED control data set may also include other data 34. Finally, the LED control data set may include a checksum 36 which may be used to aid in verifying that the LED control data set was properly transmitted.

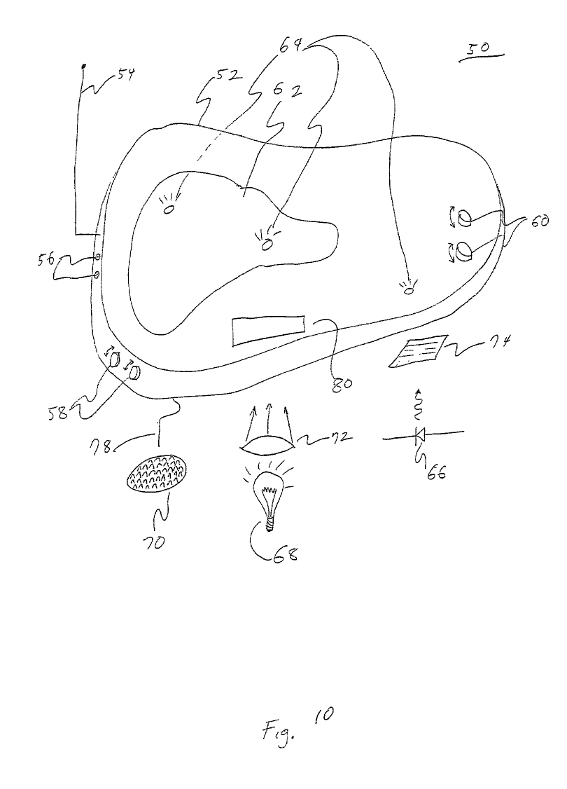

Referring to FIG. 10, an embodiment of a graphical platform 50 that can be used as the data display S16 is shown. The graphical platform 50 includes an enclosure 52, which may be a stand-alone component, or may be installed in a vehicle, aircraft, or boat. The enclosure 52 can be portable or non-portable. Attached to the enclosure 52 is an antenna 54 configured to receive electromagnetic transmissions which contain text, image and/or audio data in analog or digital form.

The graphical platform 50 may also include electrical connections 56. Although two electrical connections 56 are shown, any number of electrical connections may be included on the enclosure 52. The antenna 54 may be configured to receive electromagnetic signals. The electrical connections 56 serve to provide alternate means for the graphical platform 50 to receive information, and may further provide outputs for information signals such as an audio signal, and an input for an external power source.

The enclosure 52 may also include various adjustment mechanisms such as knobs 58 and 60. Other adjustment mechanisms such as switches, trackballs, sliders and buttons maybe included. The adjustment mechanisms can provide external control of the operation of the various functions of the graphical platform 50.

On a surface of the enclosure 52, a graphical image 62 is preferably fixed. The graphical image can be of various types such as photographs, maps, charts and graphs, etc. The graphical image may be visible during the day or night, and may include features, such as a “glow in the dark” feature to aid in night time use.

Disposed on the surface of the enclosure 52, and oriented relative to the graphical image 62 in a prescribed manner, are light sources 64. Virtually any number, any size, any density, and any resolution of light sources 64 may be included on the enclosure. The illustration sources 64 may be of various types, such as an LED 66, an incandescent bulb 68, or a plasma light source 70. Virtually any form of light source compatible with the enclosure 52 may be used. The light sources 64 may be colored and may have their intensity controllably variable. The light sources 64 may also include intermediary devices, such as a lens 72, a filter or screen 74, and fiber optics 78. The intermediary devices can serve to project, focus, guide, and otherwise convey or manipulate the light from each light source 64. The intermediary devices can also serve to filter, color, polarize, attenuate, and otherwise condition the light from its respective source.

The light sources 64 may be optically coupled to the front of the enclosure 52. The light sources 64 may be multi-colored or sized differently, or blink at different intervals to show traffic status. The light sources 64 are preferably plugged into a back plane of the electronics which are connected to a electronic controller (not shown). A typical example of using colored and blinking light sources 64 to differentiate traffic information includes using blinking red colored LEDs for major traffic alerts, non-blinking red colored LEDs for slower than normal traffic flow, green colored LEDs for normal traffic flow, and blinking green colored LEDs for faster than normal traffic flow. There are many other variations to this color and blinking technique. Any particular color and blinking frequency pattern may be designed or tailored to consumer preference. Another lighting configuration may include fiber optics optically coupled to light sources within the enclosure, with the optical fiber terminating at the map in such a way to optically display traffic information.

The enclosure 52 may also include a text or image display device such as an LCD screen 80 which can be controlled by the signal received through the antenna 54. The LCD 80 may also be controlled by signals received through the electrical connection 58. The LCD may be configured to display text messages. Alternatively, the LCD may be used to provide an controllably variable graphical image capable of displaying information received through the antenna 54 or electrical connections 58.

In operation, the graphical platform 50 may receive information in the form of electromagnetic transmission through the antenna 52. The circuitry inside the enclosure 52 may be configured to decode the transmission and control operation of the light sources 64 in accordance with the transmission. The electrical connections 56 can further receive information or power, and can provide an output signal to operate other devices

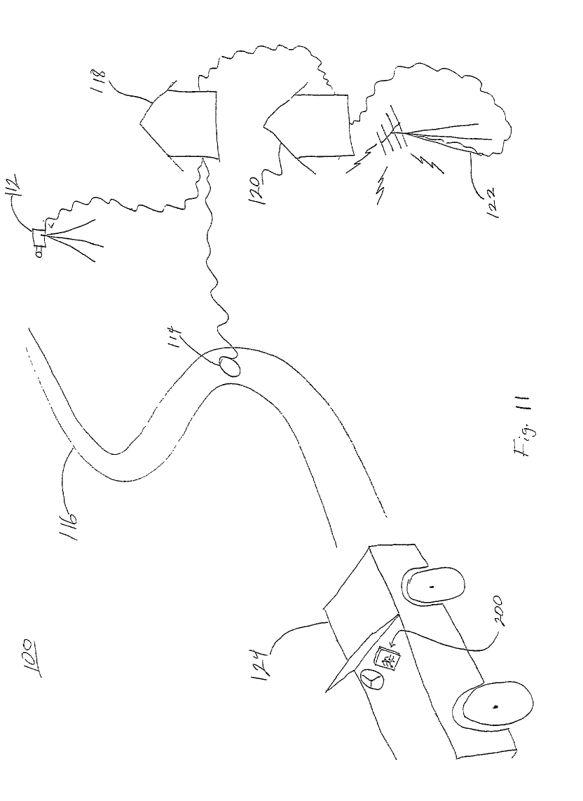

Referring to FIG. 11, one preferred embodiment of the invention directed towards a portable real-time traffic information device is shown. FIG. 11 shows a vehicle 124 with a traffic information display device 200 traveling on a roadway 116. The roadway 116 contains a traffic sensor 114 imbedded in the roadway surface. The roadway 116 may also be monitored by a camera 112. Both the sensor 114 and the camera 112 transmit traffic data to a receiving station 118. The data can be transmitted to the receiving station 118 either over data transmission lines or via wireless transmissions. The receiving station 118 then preferably transfers the data to a pager transmitter station 120. The pager transmitter station 120 formats the traffic data into a pager format, and broadcasts the data over a pager transmission antenna 122. The transmission is received by the traffic information display device 200, and displays the traffic data to the driver.

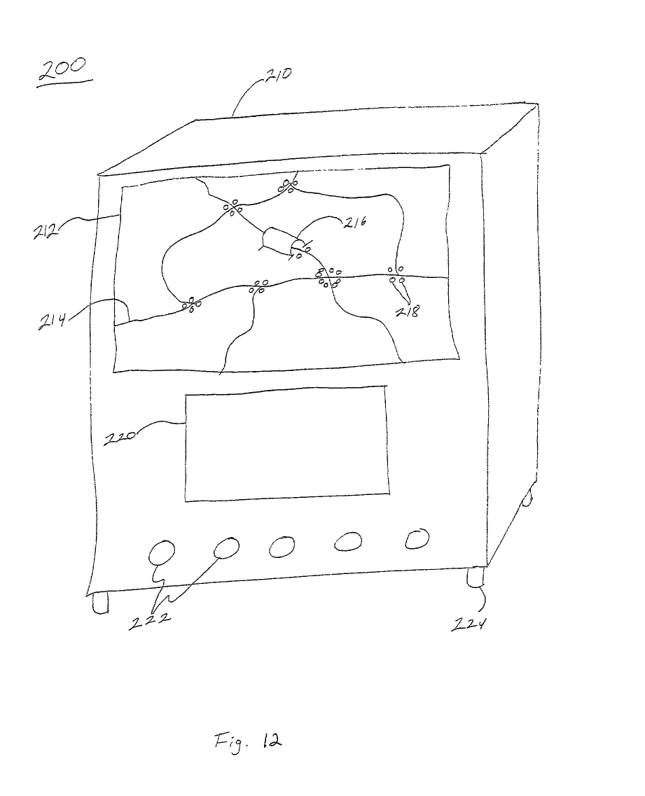

FIG. 12 shows an embodiment of a traffic information display device 200, which may be housed in an enclosure 210. The enclosure 210 supports a graphical image, such as a map 212, and may include a display screen 220. The enclosure 210 may have control buttons 222, and may have rubber feet 224 to stabilize the enclosure. In an embodiment of the invention where the graphical image is a map 212, the image may include roadways 214 and traffic related structures, such as a tunnel 216. The enclosure 210 has light sources, preferably LEDs 218, in front of, behind, or imbedded in the surface of the enclosure 210. The LEDs 218 can be placed to correspond to traffic structures 216 and roadway intersections.

As shown in FIG. 12, an embodiment of the real-time and portable traffic information device may include a map 212 of the roadway system in a chosen region with LEDs associated with prescribed locations on the roadways 214 positioned on the map 212. Although LEDs are the preferred light source, it should be appreciated that any other type of light source known in the art may be used while still falling within the scope of the present invention. The LEDs 218 may be illuminated with various colors or controlled to blink at different intervals to indicate the status of traffic conditions at the specific location represented by each LED. The LEDs 218 can be placed in a matrix or linear fashion adjacent to the map 212 of the roadway 214 system. The LEDs 218 can also be placed in front or behind the map 212, or imbedded in the map's surface.

The roadway 214 system represented by the map 212 can include any combination of freeways, tollways, interstates, surface streets, highways, etc. The map 212 can be a graphical image which is printed or otherwise affixed to a supporting surface. The graphical image of the map 212 can be a simple line drawing, a photograph, a black and white image a color image, etc. If a traffic information is sent to the traffic information display device 200 using pager transmissions, the printed map 212 is preferably a map of a metropolitan area that is covered by a single paging number. It is preferred that the printed map 212 have details sufficient to show main points of traffic interest such as, freeways, byways, bridges, tunnels, airport interchanges, public venues such as sports stadiums and amusement parks, and other features prone to traffic congestion.

Referring back to FIGS. 2-9, and the preferred embodiment of the real-time portable traffic information device shown in FIG. 12, the LEDs 218 can be controlled by a pager chip set 48 which includes a CPU 2, memory 8 and other electrical components such as a receiver module with antenna 4. Paging signal transmitters transmit message packets which may include but are not limited to a header 30, a message 32, and checksum 36 information. The message may contain enough information to switch on, switch off or blink specific LEDs 218 to display traffic status. Each LED may be individually controlled according to the message 32 information contained in the paging transmission and is updated by the paging signals from the paging transmitters. The transmitted message may be in the form of a paging signal broadcast and may update all LEDs 218 at once or sequentially. The pager chip set 48 may be configured to receive information packets and convert the message packets into alpha-numeric information. One embodiment of the invention allows for the possibility to display alpha-numeric characters. Conventional paging transmitters do not need to be modified for the present invention to work.

The embodiment of the present invention shown in FIG. 12 may also include a ID comparator chip set 12 in the portable device. Through the ID comparator chip set 12, the service provider may elect to switch on or off each device by sending the appropriate signal or message depending on its subscription status. The ID comparator chip set 12 may be used to differentiate a current subscriber from a non-subscriber. The ID comparator chip set 12 may function only when activated by a specific and unique identification number 10. The ID comparator chip set 12 also may be substituted by a removable smart chip set which can be installed by a user. In an embodiment incorporating a removable chip set 14, upon beginning or renewing a subscription, the customer could receive a smart chip through the mail, and activate the device by installing the smart chip into the smart chip holder 16. The smart chip 14 could be programmed to “expire” by switching off the device when a user's subscription has ended. Besides the ID comparator chip set 12, control of the real-time and portable traffic information device.

The ID comparator chip set 12 may have a serial number embedded in a nonvolatile memory chip which would be compared with incoming messages. A unique serial number can be included in an incoming message and can be used to activate or deactivate the device. One way to accomplish this task is to send the unique ID message at night when the traffic status change is low, and message update frequency is minimal. The unique ID message may be updated on a daily, weekly, monthly, or yearly basis depending on the length of time for which a user has subscribed.

An alternate identification method for the ID chip is to issue a smart chip upon subscription to the traffic information service. The smart chip would preferably have an embedded non-volatile memory that can be used as a password key to decipher an incoming encoded messages. The password would be valid for a certain period of time corresponding to the length of the subscription. A new chip set could be delivered to a consumer upon renewing the subscription.

The LEDs 218 are preferably placed behind, but may also be placed in front of, or imbedded in the surface of the printed map 212. The LEDs 218 may be placed adjacent to the maps freeway symbols and other symbols indicating points of traffic interest to show traffic flow at a particular point. The LEDs 218 may also be placed on the map 212 to show bridges and tunnels and other roadway structures to indicate the time required for a vehicle to negotiate the structure.

Preferable dimensions of the device enclosure 210 are approximately 8 inches by 8 inches by 0.5 inches. The enclosure 210 can be made smaller or larger depending on consumer preference, or the size of the area represented by the map 212. In a preferred embodiment, most of the front area of the enclosure 210 will be used to display a map 212. The map 212 may include printed instructions to operate the device including the meaning of the different colors of LED lights 218 and the LED blinking frequency, etc. The map 212 may be covered by a protective film to minimize glare and maximize light transmission of the LEDs 218. The enclosure 210 may be injection molded plastic to reduce weight and to enhance the comfort of holding the device. The bottom of the enclosure 210 may have rubber feet to minimize sliding on smooth surfaces.

The enclosure 210 may additionally contain multiple buttons 222 to control operation of the unit such as a button to check functionality of the LEDs, a button to check the condition of the battery, a button to display the current traffic condition after the unit has shut off automatically to reduce battery consumption, and other buttons to choose east-south bound traffic conditions or west-north bound traffic conditions, etc.

The functionality of the buttons 222 may be integrated into fewer buttons by utilizing button triggering methods. Button triggering may include a short push on a button 222 to select LED functionality control and long push of the button to select traffic information control. The front or back surface of the enclosure 210 may additionally include advertisement space.

A preferred embodiment of the present invention may include scrolling or non-scrolling alpha-numeric traffic information, or other information like stock or weather information on a LCD 220 (liquid crystal display screen), an automatic LED light dimming feature with a light sensor as feedback, a voice activated system to control the buttons described above, tuned radio frequency for traffic information, and a speaker connected to a driver circuit with memory which contains information on major traffic incidents.

In a preferred embodiment, a network of roadway sensors is used. For example, there are over 1400 roadway sensors in Los Angeles County on the freeways and major streets. Most sensors use magnetic sensing technology, but other sensors such as CCDs (charged couple device) cameras with machine vision systems, infrared sensors, acoustic sensors, and other proximity and/or velocity sensors may be suitable. As shown in FIG. 11, the sensors 112 and 114 gather the necessary traffic information and send data to a central location 118. The data stream is preferably continuous, and may include a feedback system to indicate whether a sensor is working properly or sending out erroneous data. This traffic data can be interpreted and graphically displayed in real-time. The graphic data or raw data is currently made available to the public using various methods including radio and TV stations, internet site, cable TV, local and state police agencies, etc.

The traffic data, either graphic or raw data, can be converted or translated into a paging signal data stream at a second facility 120. The data stream must be intelligent enough to be decoded at the receiver unit 200. A typical traffic sensor at specific location produces vehicle speed and location data. This information can be translated to a specific LED location on the device map and an LED color or blinking frequency to represent vehicle speed.

There are many ways to send this information via a paging data stream including but not limited to the following: 1) the data is compressed or condensed prior to sending to minimize transfer bytes; 2) only data representing changes since the last transmission, also known as “data changed data” is sent; 3) all data is sent simultaneously; and/or, 4) data is divided into multiple subsets which are sent sequentially. The data may be sent to single or multiple paging numbers within geographic area covered by a single or multiple paging numbers. In order to reduce the bandwidth required for data transmission, such transmission could be limited to, or alternate between east-south bound traffic conditions and west-north bound traffic conditions. This method would reduce the number of LEDs to be updated by each data transmission by half.

It should be noted that some types of transmission technologies may be preferable over other types based on the application. Thus, where the graphical information display is directed to a large geographical area, transmission technologies capable of covering a large geographical may be preferred. For example, satellite radio may be the preferred transmission technology where the graphical information display represents a region covering many hundreds or thousands of miles, and cell phone type transmissions may be preferred the technology where the graphical information display represents a region covering a few miles.

The foregoing embodiments and advantages are merely exemplary and are not to be construed as limiting an embodiment of the present invention. The present teaching can be readily applied to other types of apparatuses. The description of an embodiment of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A graphical information display system, comprising:
a platform;
a graphical image disposed on said platform;
a plurality of individually controllable light sources disposed on said platform proximate to said graphical image and arranged in a pattern which correlates to said graphical image; and
an electronic circuit coupled to said plurality of individually controllable light sources and configured to receive data through a wireless RF (radio frequency) transmission, and further configured to individually control said plurality of individually controllable light sources in accordance with data received through a wireless RF transmission.

2. The graphical information display system of claim 1, wherein said RF transmission comprises a transmission by a pager signal transmitting system.

3. The graphical information display system of claim 1, wherein said RF transmission comprises a transmission by a frequency modulated sub-carrier radio transmission system.

4. The graphical information display system of claim 1, wherein said RF transmission comprises a transmission by an amplitude modulated sub-carrier radio transmission system.

5. The graphical information display system of claim 1, wherein said RF transmission comprises a transmission by a short wave radio transmission system.

6. The graphical information display system of claim 1, wherein said RF transmission comprises a transmission by a microwave communication transmission system.

7. The graphical information display system of claim 1, wherein said RF transmission comprises a transmission by a satellite radio transmission system.

8. The graphical information display system of claim 1, wherein said RF transmission comprises a transmission by a digital Audio Broadcasting transmission system.

9. The graphical information display system of claim 1, wherein said RF transmission comprises a transmission by a cell phone transmission system.

10. The graphical information display system of claim 1, wherein said RF transmission comprises a transmission by a Global Systems for Mobile Communications transmission system.

11. The graphical information display system of claim 1, wherein said RF transmission comprises a transmission by a Wireless Application Protocol transmission system.

12. The graphical information display system of claim 1, wherein said data comprises motor vehicle traffic information.

13. The graphical information display system of claim 1, wherein said graphical image comprises a map.

14. The graphical information display system of claim 13, wherein said map comprises a map of roadways.

15. The graphical information display system of claim 13, wherein said map covers the roadways of a region serviced by a plurality of pager numbers.

16. The graphical information display system of claim 13, wherein said map covers the roadways of a region serviced by a single pager number.

17. The graphical information display system of claim 1, wherein said electronic circuit comprises a pager chip set.

18. The graphical information display system of claim 17, wherein said pager chip set comprises a bi-directional pager chip set.

19. The graphical information display system of claim 17, wherein said pager chip set comprises a uni-directional pager chip set.

20. The graphical information display system of claim 1, wherein said electronic circuit further comprises an identification chip set.

21. The graphical information display system of claim 20, wherein said identification chip set comprises a non-volatile memory.

22. The graphical information display system of claim 20, wherein said identification chip set comprises a smart chip.

23. The graphical information display system of claim 20, wherein said smart chip is user replaceable.

24. The graphical information display system of claim 1, wherein said plurality of individually controllable light sources are configured to be further controlled by at least one user operated switch.

25. The graphical information display system of claim 1, wherein said electronic circuit is configured to receive data by a push-type data transfer.

26. The graphical information display system of claim 1, further comprising an LCD (liquid crystal display).

27. A method of graphically displaying information, comprising:
arranging a plurality of individually controllable light sources adjacent to a graphical image a nd in a pattern correlating to said graphical image;
receiving data from a wireless RF transmission with a first electronic circuit; an
individually controlling said plurality of individually controllable light sources in accordance to said data from a wireless RF transmission with a second electronic circuit.

28. The method of claim 27, wherein receiving data from a wireless RF transmission comprises receiving a pager signal transmission.

29. The method of claim 27, wherein receiving data from a wireless RF transmission comprises receiving a frequency modulated sub-carrier radio transmission.

30. The method of claim 27, wherein receiving data from a wireless RF transmission comprises receiving an amplitude modulated sub-carrier radio transmission.

31. The method of claim 27, wherein receiving data from a wireless RF transmission comprises receiving a short wave radio transmission.

32. The method of claim 27, wherein receiving data from a wireless RF transmission comprises receiving a microwave communication transmission.

33. The method of claim 27, wherein receiving data from a wireless RF transmission comprises receiving a satellite radio transmission.

34. The method of claim 27, wherein receiving data from a wireless RF transmission comprises receiving a Digital Audio Broadcasting transmission.

35. The method of claim 27, wherein receiving data from a wireless RF transmission comprises receiving a cell phone transmission.

36. The method of claim 27, wherein receiving data from a wireless RF transmission comprises receiving a Global Systems for Mobile Communications transmission.

37. The method of claim 27, wherein receiving data from a wireless RF transmission comprises receiving a Wireless Application Protocol transmission.

38. The method of claim 27, wherein receiving data from a wireless RF transmission with a first electrical circuit comprises receiving a wireless RF transmission with a pager chip set.

39. The method of claim 27, wherein receiving data comprises receiving traffic related data.

40. The method of claim 27, further comprises controlling said individually controllable light sources in accordance with electronic commands form an identification chip set.

41. A method of graphically displaying information, comprising:
receiving traffic-related data from a wireless RF transmission;
selectively activating certain light sources of a plurality of individually controllable light sources in accordance with data from a wireless RF transmission, wherein said plurality of individually controllable light sources are located adjacent to a graphical image.

42. A display device, comprising:
a fixed image;
at least one light source disposed proximate to said fixed image;
an electronic circuit coupled to said at least one light source, wherein said electronic circuit is configured to receive information from a source external to said electronic circuit and control the functioning of said at least one light source in accordance with the received information.

43. A method of transmitting vehicle information, comprising:
detecting vehicle data with at least one sensor;
formatting the data into a prescribed format; and
transmitting the data over an information system compatible with the prescribed format.

44. The method of transmitting vehicle information of claim 29, wherein the information system comprises a pager system.

45. A traffic information system comprising the graphical information display system of claim 1.

46. An information system, comprising:
a sensor configured to provide a transmitter with traffic information;
a graphical information display configured to receive traffic information from the transmitter.

47. The information system of claim 46, wherein the graphical information display receives the traffic information from the transmitter through an RF transmission.
